(19) United States
(12) Patent Application Publication
(10) Pub. No.: US 2005/0097721 A1
(43) Pub. Date: May 12, 2005

(54) High pressure sensor with knurl press-fit assembly

(76) Inventors: Daniel J. Bratek, Palatine, IL (US); Philip Kang, Northbrook, IL (US); Robert C. Kosberg, Wildwood, IL (US); James L. Nowicki, Chicago, IL (US)

Correspondence Address: MOTOROLA, INC., 1303 EAST ALGONQUIN ROAD, IL01/3RD, SCHAUMBURG, IL, 60196, US

(21) Appl. No.: 10/702,346

(22) Filed: Nov. 6, 2003

(51) Int. Cl. B23P 11/00

(52) U.S. Cl. 29/505; 29/890.09

(57) ABSTRACT

A method of assembling a high pressure sensor with knurl press-fit includes a first step of providing a pressure port having a material with a first hardness and a housing having a material with a second hardness less than the first hardness. The pressure port has a mounting boss and the housing has a receptacle for receiving the mounting boss. A next step includes configuring the mounting boss of the pressure port with knurls thereon. A next step includes pressing the mounting boss of the pressure port into the receptacle of the housing along a direction of the axis such that the knurls deform the receptacle of the housing to conform about the knurls to define a semi-rigid mount.

### FIELD OF THE INVENTION

This invention in general relates to high pressure sensors and, more particularly, to a high pressure sensor assembly.

### BACKGROUND OF THE INVENTION

High pressure sensors are used in a variety of applications. Such applications can include hydraulic systems in machinery or automotive fuel injection systems. In particular, high pressure sensors can be used in automotive applications such as transmission fluid pressure sensing, oil pressure sensing, fuel injection pressure sensing and brake fluid pressure sensing. Typically, such applications subject the sensor to an adverse environment requiring precision assembly using durable materials. In addition, pressure sensors in automotive applications are subject to stresses other than the fluid pressure. For example, installation and assembly of the sensor along with temperature changes during use submit the sensor to external forces that the sensor must be capable of withstanding. These requirements have resulted in pressure sensors with complex, multi-part assemblies that incur a high cost.

One prior art sensor provides a three-piece stainless steel pressure sensor, which requires two pieces to be welded together and then crimped into a metal housing with an o-ring seal. However, the welding and crimping process add cost, and the o-ring seal cannot seal high pressures. The fluid is in contact with the weld which may present corrosion issues. Also, the o-ring limits the amount of pressure that can be applied.

Another prior art pressure sensor assembly has a sensor header which is laser welded to a metal housing. However, the laser welding is a process requiring expensive equipment and good accuracy, which adds cost. In addition, the laser welded material must be compatible with, and able to withstand, the fluid media exposure. Further, this assembly provides a very rigid form of attachment which may transmit too much mounting stress resulting in errors in the pressure signal.

Another prior art pressure sensor includes a separate pressure port which is held in a metal housing with the use of a spring clip. It is also locked in place with an epoxy material. This process requires an extra part and an adhesive material that must undergo some cure process.

Another prior art pressure sensor provides a simple sensor design that is glued into a metal baseplate housing. Unfortunately, this type of assembly is not a strong method of retention, especially in tension. Also, this assembly requires a cure of the materials.

Therefore, a need exists for a low cost, high pressure assembly that is able to withstand the internal and external stresses in an automotive environment. It would also be desirable to provide such improvement in a simple, one-piece assembly that limits the potential for lateral movement damage.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, and wherein:

FIG. 1 is an exploded and cutaway view of a pressure port and housing in accordance with the present invention;

FIG. 2 is a cross-sectional view of the assembly of the pressure port and housing of FIG. 1; and

FIG. 3 is a flow chart of a method, in accordance with the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the broad scope of the invention as defined by the appended claims.

### DETAILED DESCRIPTION OF THE PREFERRED EMBODIMENTS

The present invention provides a low cost, high pressure assembly that is able to withstand the internal and external stresses in an automotive environment. The sensor assembly is a simple, one-piece assembly that is semi-rigid, which allows some lateral movement to prevent mounting stress sensor error.

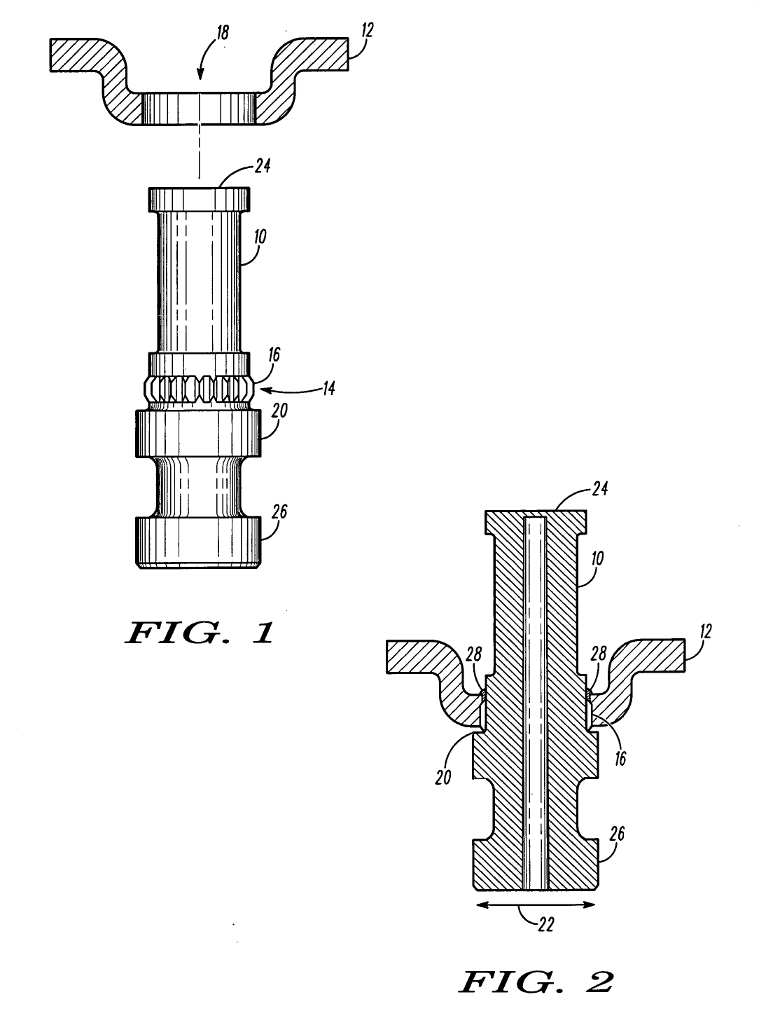

Referring to FIGS. 1 and 2, the present invention provides a high pressure sensor assembly using a knurled, one-piece pressure port 10 to be press fit into a metal baseplate housing 12. Preferably, the knurl is a straight-knurl. However, a diamond, or other pattern, knurl can also be used. The pressure port 10 is roughly cylindrical and has a mounting boss 14 with knurls 16 formed around a diameter thereof. Preferably, the knurls are straight knurls oriented parallel to an axis of the pressure port. The straight knurled pattern is easy to produce on the pressure port using known rolling or cutting techniques and adds little cost to the part. Due to the nature of the interference between the two pieces, tight tolerances, which are common for press fit designs, are not required. The mating hole or receptacle 18 is simply drilled into the mating housing 12 using a standard drill size with standard tolerances. The tolerances required on the knurls 16 and the receptacle 18 are larger than standard press fit tolerances therefore do not add significant costs.

The hardness of the metal components is critical to the operation of the press fit. The knurled portion is much harder than the housing, thus allowing the housing material to deform away from the peaks of the knurls and flow into the open spaces of the valleys of the knurl. Specifically, the pressure port is made of hardened stainless steel and the housing is made of aluminum. Therefore, during assembly the peaks of the knurls press into the softer housing receptacle deforming material around the knurl teeth resulting in a tight fit around the pressure port. The valleys of the knurls allow for some extra space for the deformed material to press into.

In addition it is very simple to assemble the components together. It can be done manually or with automated equipment to achieve good reproducibility. The attachment process is extremely simple and does not require any expensive equipment. In addition, no extra fasteners are required for the assembly. The parts are essentially held so they are on the same axis and pushed together. As the port reaches its final position a flat shoulder 20 abuts the surface of the housing 12 thus resulting in an exponential increase in force per unit displacement, indicating that the pressure port is fully seated. The receptacle 18 of the housing 12 conforms about the knurls 16 of the mounting boss 14 and forms a semi-rigid mount.

The attachment is semi-rigid, meaning that it is rigid against push-out and torque-out forces but does not totally constrain the port allowing some lateral movement 22 if needed. Therefore, the present invention has better stress isolation of the pressure port to external stresses which results in better accuracy in the pressure measurement. In application, the pressure port has the potential to have a lateral (i.e. side loading) force applied to the port at some distance below the knurl. This is because the pressure port is pressed in and can resist lateral forces to some degree depending on a number of factors including: the interference amount, the distance at which the force is applied relative to the press fit area (i.e. moment arm), the softness of the material pressed into, and the magnitude of the force applied.

In a preferred embodiment, to provide a leak tight junction, a seal 28 is provided between the port and the housing. The seal can be made using a dispensed seal material, an axial o-ring or gasket seal on the shoulder, or a radial seal above the knurled diameter. Preferably, a silicone glue is dispensed around the top of the knurled portion between the port 10 and the housing 12. This seal also allows lateral movement of the port while preventing leaks.

In practice, the present invention uses a 30 tooth-per-inch straight knurl pattern. The knurl outer diameter ranges from 8.94 to 8.81 mm and the peak to valley distance or tooth depth is approx. 0.6096 mm (using a standard knurl tolerance). The receptacle of the housing is 8.5 mm+/−0.05 mm which is a standard drilled hole tolerance. The dimensions were chosen, because they are easy to maintain without any special attention, which results in no additional costs.

Also important are the length of the knurl and the depth of the receptacle. In some materials that are brittle or have a high modulus of elasticity, the knurl actually cuts the material away to some degree as well as local deformation on the peaks of the knurls. Therefore, there is the concern of metal chips being created inside the pressure sensor module which could disperse and cause electrical problems. To resolve this issue, the length of the knurl was made less than the depth of the receptacle such that the knurl pattern did not go through the entire depth of the receptacle during assembly. This leaves an undeformed portion in the receptacle that actually traps any chips in place. Specifically, the straight knurl length is three millimeters and the depth of the receptacle is four millimeters, leaving one millimeter of undeformed space to trap the debris formed. Note that this chip debris phenomena does not occur in materials with higher ductility as the material would just deform and not create any metal chips. In addition a bevel is provided on the leading edge of the teeth of the straight knurls to assist in alignment during the press fit and to ease assembly by providing gradual deformation with less potential for chips. Preferably, the bevel is at 60°.

The length of the knurl, especially in materials that work harden, such as plain steel, is an important factor as to the ease of the press fit assembly process. As material is deformed, the deformation makes the material harder and increases its strength. Therefore as the material moves when the knurl presses into it, it will locally increase in strength and the more it presses thru, the more material gets deformed in front of it making it harder and harder to press as it goes in. Some materials will react differently, based on their material properties and therefore, they may not be optimal for press fits greater than a certain length. The present invention uses hardened stainless steel for the port and aluminum for the housing, which readily deforms.

In operation, the top side of the pressure port 10 contains an integral diaphragm 24 that is exposed to the ambient pressure inside the pressure sensor module. A piezo-resistive transducer deposited in silicon is bonded to the diaphragm 24, to measuring pressure relative to the atmospheric pressure surrounding it. The bottom of the port 26 is coupled to the fluid to be measured. In a transmission fluid application, the pressure range that the bottom of the part is exposed to is a standard pressure that is used in transmission ducting, and can vary from 0 to 70 Bar gauge pressure. However, it should be recognized that the pressure sensor assembly of the present invention can be used in various pressure applications including engine oil pressure, braking systems, fuel injection systems, and the like.

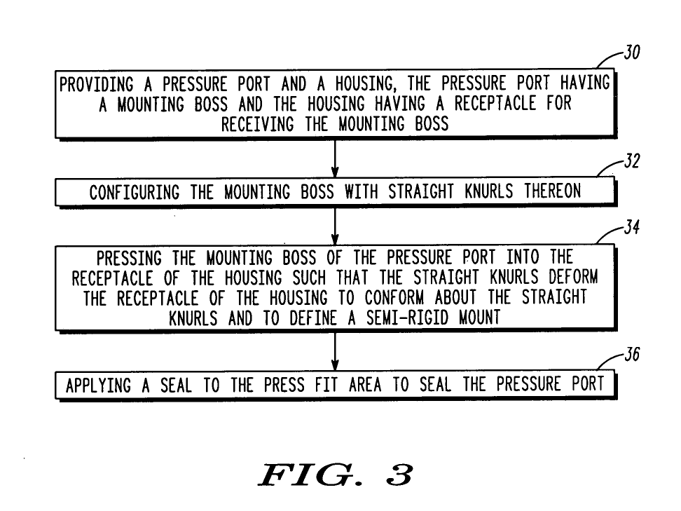

Referring to FIG. 3, the present invention also provides a method of assembling a high pressure sensor with knurl press-fit. The method includes a first step 30 of providing a pressure port having a material with a first hardness and a housing having a material with a second hardness less than the first hardness. Specifically, a hardened stainless steel pressure port and an aluminum housing are provided. The pressure port has a mounting boss and the housing has a receptacle for receiving the mounting boss, wherein a length of the knurls that is less than a depth of the receptacle.

A next step 32 includes configuring the mounting boss of the pressure port with knurls thereon. Preferably, the knurls are straight knurls oriented parallel to an axis of the pressure port. The knurls of the mounting boss and the receptacle are configured to have an interference fit. Preferably, this step also includes configuring a shoulder on the mounting boss. The straight knurls are formed having a peak-to-valley distance of less than one millimeter, and preferably 0.6 millimeter. An outer diameter of the straight knurls of the mounting boss is less than 0.5 millimeter larger than a diameter of the receptacle, and preferably 0.4 millimeter larger than a diameter of the receptacle.

A next step 34 includes pressing the mounting boss of the pressure port into the receptacle of the housing along a direction of the axis such that the knurls deform the receptacle of the housing to conform about the knurls to define a semi-rigid mount. With a shoulder on the pressure port, the pressure port is pressed into the receptacle of the housing up to the shoulder.

A next step 36 includes applying a seal to the press fit area to seal the pressure port. Preferably, this seal is a silicone glue disposed in a radial seal on top of the knurls between the pressure port and the housing.

The present invention provides a semi-permanent technique for attachment that provides a semi-rigid mount and still provides isolation from mounting stresses. The assembly process is very simple and does not require any expensive manufacturing equipment.

The above description of the present invention is intended to be exemplary only and is not intended to limit the scope of any patent issuing from this application. The present invention is intended to be limited only by the broad scope of the following claims.

1. A method of assembling a high pressure sensor with knurl press-fit, the method comprising the steps of:
providing a pressure port having a material with a first hardness and a housing having a material with a second hardness less than the first hardness, the pressure port having a mounting boss and the housing having a receptacle for receiving the mounting boss;
configuring the mounting boss of the pressure port with knurls thereon, the knurls oriented parallel to an axis of the pressure port; and
pressing the mounting boss of the pressure port into the receptacle of the housing along a direction of the axis such that the knurls deform the receptacle of the housing to conform about the knurls to define a semi-rigid mount.

2. The method of claim 1, wherein the configuring step includes configuring a shoulder on the mounting boss, and wherein the pressing step include pressing the mounting boss into the receptacle of the housing up to the shoulder.

3. The method of claim 1, wherein the providing step includes providing a stainless steel pressure port and an aluminum housing.

4. The method of claim 1, wherein the providing step includes providing a length of the knurls that is less than a depth of the receptacle.

5. The method of claim 1, wherein the configuring step includes configuring the knurls of the mounting boss and the receptacle to have an interference fit.

6. The method of claim 1, wherein the configuring step includes configuring the mounting boss with straight knurls.

7. The method of claim 1, further comprising the step of applying a seal to the press fit area to seal the pressure port.

8. A method of assembling a high pressure sensor with straight knurl press-fit, the method comprising the steps of:
providing a pressure port having a material with a first hardness and a housing having a material with a second hardness less than the first hardness, the pressure port having a mounting boss and the housing having a receptacle for receiving the mounting boss;
configuring the mounting boss of the pressure port with straight knurls thereon, the straight knurls oriented parallel to an axis of the pressure port, the mounting boss also configured with a shoulder at a first end of the straight knurls; and
pressing the mounting boss of the pressure port into the receptacle of the housing along an axial direction of the pressure port up to the shoulder such that the straight knurls deform the receptacle of the housing to conform about the straight knurls to define a semi-rigid mount.

9. The method of claim 8, wherein the configuring step includes configuring the straight knurls to have bevel on an end thereof.

10. The method of claim 8, wherein the providing step includes providing a hardened stainless steel pressure port and an aluminum housing.

11. The method of claim 8, wherein the configuring step includes configuring the straight knurls of the mounting boss and the receptacle to have an interference fit, and wherein a length of the straight knurls is less than a depth of the receptacle.

12. The method of claim 8, further comprising the step of applying a silicone glue to the press fit area to seal the pressure port.

13. A high pressure sensor with a knurl press-fit assembly apparatus comprising:
a pressure port having a material with a first hardness, the pressure port having a mounting boss with knurls thereon, the knurls oriented parallel to an axis of the pressure port; and
a housing having a material with a second hardness less than the first hardness, the housing having a receptacle conforming about the knurls of the mounting boss and forms a semi-rigid mount.

14. The apparatus of claim 13, wherein the pressure port includes a shoulder on the mounting boss, and wherein the shoulder abuts the housing, and wherein the pressure port is made of stainless steel and the housing is made of aluminum.

15. The apparatus of claim 13, further comprising a seal applied between the pressure port and housing.

16. The apparatus of claim 13, wherein the pressure port has straight knurls thereon with a length less than a depth of the receptacle.
